(19) United States
(12) Patent Application Publication
(10) Pub. No.: US 2006/0025083 A1
(43) Pub. Date: Feb. 2, 2006

(54) Display switcher with mobile communication interface

(76) Inventors: Hsi Che Lee, Taipei (TW); Tung Hsing Pan, Taipei (TW); Mei-Jiuan Chen, Taipei (TW)

Correspondence Address: BIRCH STEWART KOLASCH & BIRCH, PO BOX 747, FALLS CHURCH, VA, 22040-0747, US

(21) Appl. No.: 10/900,346

(22) Filed: Jul. 28, 2004

(51) Int. Cl. H04B 1/38; H04M 1/00

(52) U.S. Cl. 455/90.1; 455/566; 455/557

(57) ABSTRACT

A display switcher with mobile communication interface comprising a switching circuitry, an image processor, a central processor, a memory unit and a mobile communication interface; the central processor transmits control signals to the switching circuitry based on internal program to have the switching circuitry switch the images automatically and capture images from different cameras, the images are converted into digital signals and edited, stored into said memory unit, the central processor compares the current image signals of every camera with last image stored in the memory unit for difference, the mobile communication interface transmits signals in mobile phone protocol through a mobile phone, the remote site mobile phone receives and displays the image signal on screen for remote monitoring function for safety purpose.

### BACKGROUND OF THE INVENTION

I. Field of the Invention

This invention relates generally to a display switcher and, more specifically, to a display switcher with mobile communication interface that transmits the image signals captured by cameras to a remote site mobile phone and display on the screen of the remote site mobile phone as a remote monitoring function for safety purpose.

II. Description of the Prior Art

Heretofore, it is known that display switches are applied on the security systems of buildings or offices, the areas of buildings and offices are general very large to have guards or security personnel watch everywhere, therefore cameras are used to monitor, the display switches can watch a plurality cameras to a monitor, the display switch can switch various frames with definite time period; the monitors are installed on some stationary location, when guards go to check some abnormal situation, they cannot watch the monitors at the same time.

The monitor systems need people to watch all the time, general residential environments are not suitable to install such monitor system; burglar intrusion or abnormal situation often happen when all the family members are out for work or travel, such as fire, such situation is aware only when it is very serious or when people return home, the situation is very dangerous if burglar is still inside the house; children are often left at home when young parents have to go out or work, young children might cause danger while playing, such as fire; elderly people having health problems might have emergency condition and need treatment.

### SUMMARY OF THE INVENTION

It is therefore a primary object of the invention to provide a display switcher with mobile communication interface that transmits the image signals captured by cameras to a remote site mobile phone and display on the screen of the remote site mobile phone as a remote monitoring function for safety purpose.

In order to achieve the objective set forth, a display switcher with mobile communication interface in accordance with the present invention comprises a switching circuitry, an image processor, a central processor, a memory unit and a mobile communication interface; the central processor transmits control signals to the switching circuitry based on internal program to have the switching circuitry switch the images automatically and capture images from different cameras, the images are converted into digital signals and edited, stored into said memory unit, the central processor compares the current image signals of every camera with last image stored in the memory unit for difference, the mobile communication interface transmits signals in mobile phone protocol through a mobile phone, the remote site mobile phone receives and displays the image signal on screen for remote monitoring function for safety purpose.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an application view of the present invention;

FIG. 2 is a block diagram of the present invention.

### DESCRIPTION OF THE PREFERRED EMBODIMENT

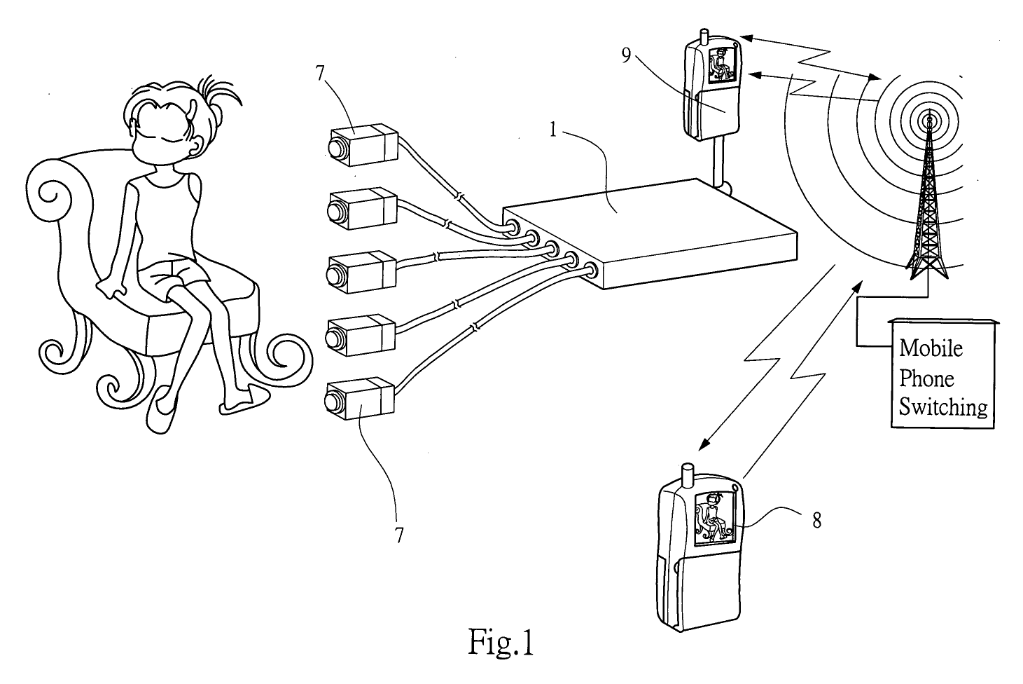

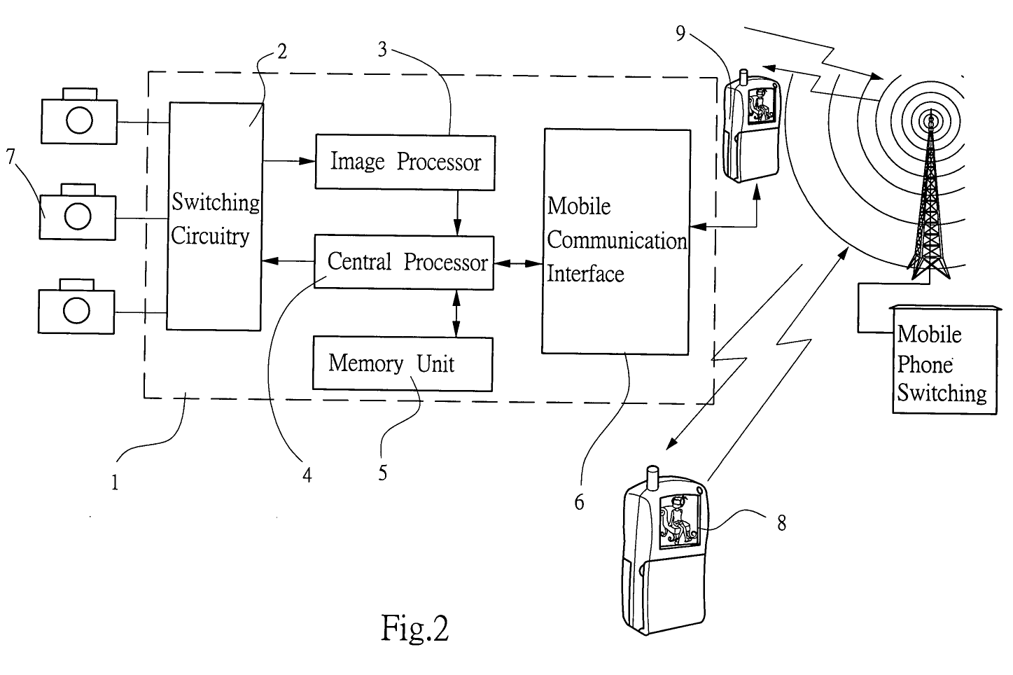

Referring to FIG. 1 and FIG. 2, the present invention comprises a switching circuitry 2, an image processor 3, a central processor 4, a memory unit 5 and a mobile communication interface 6. The function of each component is described as following:

The switching circuitry 2 of the display switcher with mobile communication interface 1 connects to a plurality of cameras 7 with image paths; the switching circuitry 2 switches the image paths in order or switches to the selected image path by the program or instruction of the central processor 4, the image signals captured by the cameras 7 can also be switched in order in a definite time period; when the switching circuitry 2 switches to one of the cameras 7, the image signals captured by that camera 7 are sent to the image processor 3. The image signals captured by the camera 7 are analog signals, the analog signals are converted into digital signals by the image processor 3, and those digital signals are transmitted to the central processor 4. The mobile communication interface 6 connects to the mobile phone 9 and applies the mobile phone 9 to receive and transmit mobile wireless digital signals. The central processor 4 stores image signals into the memory unit 5 and controls different functions of the display switcher with mobile communication interface 1 based on internal program or external commands.

Based on above description, when all the family members are out, the display switcher with mobile communication interface 1 is set to automatic alarm mode, the central processor 4 transmits control signals to the switching circuitry 2 automatically based on internal program to have the switching circuitry 2 switch the images automatically and capture images from different cameras 7, the images are converted into digital signals and edited, stored into the memory unit 5 by the central processor 4. The central processor 4 compares the current image signals of every camera 7 with last image stored in the memory unit 5 for difference, if difference happens, the central processor 4 determines the abnormal condition might occur (burglar intrusion or fire alert), the central processor 4 transmits the warning messages and that image signals to the mobile communication interface 6, the mobile communication interface 6 transmits the warning messages and the image signals in mobile phone protocol through the mobile phone 9, the warning messages and the image signals go through macrocell and mobile phone switchboard, then the macrocell transmits the warning message and the image signals to the designated mobile phone 8. Based on above description, users can see the warning message and the image signals through the designated mobile phone 8; users can call police or fire department for assistance to reduce loss.

The display switcher with mobile communication interface 1 not only has the image signals comparison capability as monitor function but also can connect to the anti-theft sensors or doorbells to collect the signals from the anti-theft sensors or doorbells, if abnormal signals are detected or the doorbells are pressed, the warning messages and image signals are transmitted to the designated mobile phone 8, users can call police or fire department for assistance or see who presses the doorbell for emergency assistance, users can rush back at the same time.

When elderly people or young children are alone at home, the display switcher with mobile communication interface 1 can be set on monitoring mode; users can call the designated number to view the image signals, the mobile communication interface 6 receives the commands from macrocell and mobile phone switchboard from the mobile phone 9 and transmits the commands to the central processor 4, the central processor 4 passes the captured image signals of a designated or a plurality of cameras 7 to the designated mobile phone 8 through the mobile communication interface 6, and displays the image signals of the designated or a plurality of cameras 7 in sequence; users can view the physical condition of elderly people or the situation of the young children as safety precaution.

The mobile communication interface 6 includes a wireless receiving/transmission module of the mobile phone 9 to have the display switcher with mobile communication interface 1 transmit and receive wireless signals without connecting to a mobile phone 9.

While a preferred embodiment of the invention has been shown and described in detail, it will be readily understood and appreciated that numerous omissions, changes and additions may be made without departing from the spirit and scope of the invention.

What is claimed is:

1. A display switcher with mobile communication interface comprising:
a switching circuitry connects to a plurality of cameras with image paths and a central processor, said switching circuitry switches the image paths in order or switches to the selected image path by the program or instruction;
said image processor connects to said switching circuitry and said central processor, said image processor converts the analog signals captured by the cameras into digital signals;
said central processor connects to said switching circuitry, said image processor, a memory unit and a mobile communication interface, said central processor compares the variation of digital image signals and controls the whole system;
said memory unit connects to said central processor, said memory unit stores digital image signals and related information;
said mobile communication interface connects to said central processor and a mobile phone, said mobile communication interface transmits, receives signals in the mobile phone protocol, said central processor transmits control signals to said switching circuitry automatically based on internal program to have said switching circuitry switch the images automatically and capture images from different cameras, the images are converted into digital signals and edited, stored into said memory unit, said central processor compares the current image signals of every camera with last image stored in said memory unit for difference, if difference happens, said central processor determines the abnormal condition might occur, said central processor transmits the warning messages and that image signals to said mobile communication interface, said mobile communication interface transmits the warning messages and the image signals in mobile phone protocol through the mobile phone, the warning messages and the image signals go through macrocell and mobile phone switchboard, then the macrocell transmits the warning message and the image signals to the designated mobile phone, users can see the warning message and the image signals through the designated mobile phone, users can call police or fire department for assistance to reduce loss.

2. The display switcher with mobile communication interface recited in claim 1, wherein said mobile communication interface includes a wireless receiving/transmission module of the mobile phone 9 to transmit and receive wireless signals in mobile phone protocol.
